(19) United States
(12) Patent Application Publication
(10) Pub. No.: US 2009/0228823 A1
(43) Pub. Date: Sep. 10, 2009

(54) USER INTERFACE FOR PORTABLE STORAGE DEVICES

(75) Inventors: Rodney Edwards, Seattle, WA (US); Cinthya Urasaki, Seattle, WA (US); Adam Bronsther, Bothell, WA (US); William Poole, Bellevue, WA (US); Simon Earnshaw, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/043,956

(22) Filed: Mar. 7, 2008

(51) Int. Cl. G06F 3/048

(52) U.S. Cl. 715/772; 715/765

(57) ABSTRACT

A user interface for portable storage devices is disclosed. The user interface includes an icon that is displayed as part of the portable storage device. The icon can provide storage information. It can also provide a synchronization, backup, and file transfer animation. One or more of the following visual cues can be provided: a visual cue to indicate the amount of additional memory that will be consumed before performing a copy/transfer task, a visual cue to indicate whether it is safe or unsafe to eject the portable storage device, a visual cue to indicate an alert or conflict condition, and a visual cue to indicate the success or completion of an activity. The same type of icon and visual cues can be displayed on the host system. The host system can also display an enhanced version of the icon as well as a menu to give additional details pertaining to the state and contents of the portable storage device. An expanded view can be implemented to provide protection information. Thereby, a comprehensive, integrated, end-to-end user interface design for portable storage devices that is intuitive and easy to understand and use is provided.

### BACKGROUND

Portable storage devices used for storing digital data, such as USB (universal serial bus) drives, are becoming ever more popular. Their wide spread use and adoption is due in part to their small size and light weight. Moreover, USB drives are removable and rewritable. And because USB drives contain no moving parts, they are compact, reliable, and durable. In addition, USB drives are quite easy to use. To load data, the USB drive is simply plugged into a USB port on a host system (typically a personal computer) or into a USB hub (e.g., a USB connection built into a keyboard, monitor, etc.). The USB port provides the requisite power and offers a standard input/output (I/O) interface. Data stored on a host system is simply selected, dragged and dropped onto the USB drive. Likewise, data can be transferred from a USB drive by selecting, dragging, and dropping the data onto the host system's destination memory device, such as a hard disk drive. Data can also be accessed directly from the USB drive once it has been plugged into a host device. Moreover, advances in non-volatile flash memory technology continue to increase capacity while lowering costs. All of these advantages make USB drives ideal for temporarily storing and physically transporting digital data.

A USB drive typically consists of a small printed circuit board encased in plastic or metal. Mounted on the printed circuit board are the flash memory chip and a few integrated circuit chips to provide the interface to the USB port and to control/drive the flash memory. A USB connector used to couple the USB drive to a host system, protrudes from the body of the casing and is protected by a cap. Many USB drives also include an LED (light emitting diode). The LED light is turned on/off to indicate whether the USB drive is active or inactive. In other words, the LED light is turned on when data is being written to or read from the USB drive; otherwise, the LED light is turned off. In some cases, the LED can be made to flash to signal that an activity is occurring.

Unfortunately, this LED light sheds very little information regarding the actual state of the USB drive. Based solely on the LED, the user has no way of knowing how much capacity the USB drive has left. Consequently, the user has to guess at whether the USB drive has enough capacity available to store selected file(s). And even if there is enough capacity, the LED does not contain any indication as to how much additional storage will be consumed when writing specific files or data to the USB drive nor how much capacity will remain after the data transfer completes. Furthermore, the LED cannot inform the user of the current progress of a data transfer. The user may also be interested in knowing whether data is protected. Sensitive and critical data should be protected in order to prevent this data from being overwritten or otherwise erased and lost. Again, the LED yields no information as to whether certain data is protected. Another drawback is that the LED light does not convey to the user that the USB drive is in the process of synchronizing or backing up the data. In some situations, it may be unsafe to unplug the USB drive; data could become corrupted or damaged. With nothing more than a simple LED, the user has no guaranteed way as to knowing when it would be safe or unsafe to unplug the USB drive.

Another shortcoming of typical USB drives is that there is no input mechanism to instruct the USB drive to stop, pause, or resume its operations.

Furthermore, because the USB drive is typically manufactured by a company different from the company that manufactures the host system, there is no uniform user interface common to both the USB drive and the host system. It is left to the user to learn how to interpret all of the bewildering array of indicators and user interfaces, both hardware and software, commercially distributed by all of the numerous USB drive and host system manufacturers. Hitherto, there has not been a comprehensive, integrated, end-to-end user interface design that is intuitive and satisfies the end needs of the user.

### SUMMARY

This Summary is provided to introduce a selection of concepts in a simplified form that are further described below in the Detailed Description. This Summary is not intended to identify key features or essential features of the claimed subject matter, nor is it intended to identify key features or essential features of the claimed subject matter, nor is it intended to be used as an aid in determining the scope of the claimed subject matter.

An integrated, comprehensive, end-to-end user interface that visually conveys one or more states of a portable storage device is disclosed. The user interface includes an icon that is displayed as part of the portable storage device. The icon can provide storage information, a synchronization animation, protection animation, a visual cue for the amount of additional memory that will be consumed before performing a copy or transfer task, unsafe to eject indication, and protection level. The same type of icon can also be displayed on the host system. The host system can also display an enhanced version of the icon as well as a menu to give additional details pertaining to the protection level and contents of the portable storage device. One or more buttons can be included to stop, pause, and resume operation. Thus, with a quick glance at the user interface, much information regarding the operation, content, and status of the portable storage device can be conveyed.

### DESCRIPTION OF THE DRAWINGS

The accompanying drawings, which are incorporated in and form a part of this specification, illustrate embodiments of the invention and, together with the description, serve to explain the principles of the invention:

FIG. 1 shows an example of a user interface for a portable storage device.

FIG. 2 shows a circular icon which is used to convey the amount of storage that will be necessary in order to store a particular selected file.

FIG. 3 shows one embodiment of a separate visual indicator that is integrated as part of the circular icon.

FIG. 4 shows a menu which is displayed on the screen of a host system for conveying information regarding a portable storage device.

FIG. 5 shows another embodiment of a menu that can be used to portray the state of a portable storage device.

FIG. 6 shows the hardware associated with a USB drive user interface.

FIG. 7 shows hardware associated with a host system for implementing a portable storage device user interface.

FIG. 8 shows the software process for implementing a user interface for a portable storage device.

FIG. 9 shows the software process for implementing the user interface for a host system.

FIG. 10 shows a software architecture that can be used to implement a user interface for portable storage devices.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

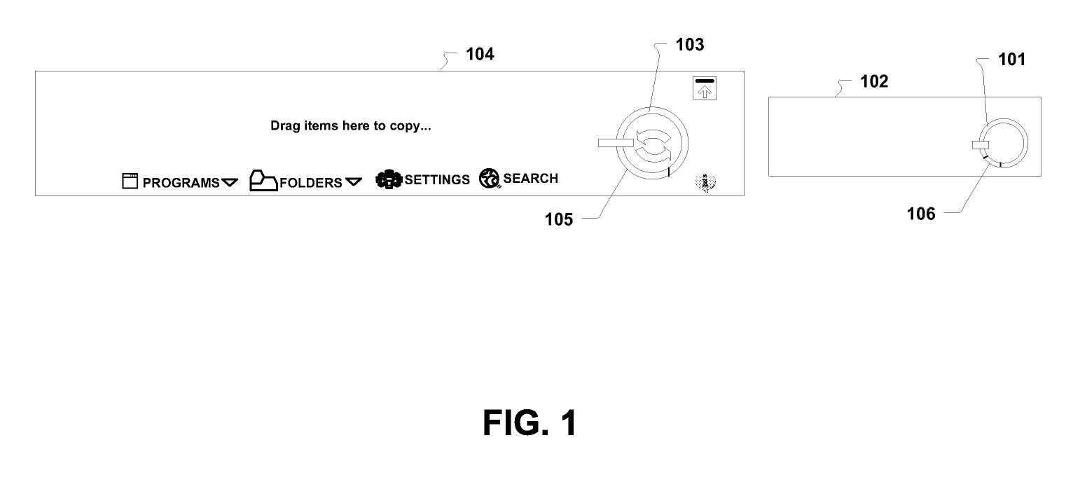

A method and system for an integrated, comprehensive, end-to-end user interface that visually conveys the state of a portable storage device is disclosed. By glancing at this user interface, the user can glean much useful knowledge regarding the current state of the portable storage device. FIG. 1 shows one example of such a user interface. In this particular example, the user interface is represented as a circular icon intersecting with a short horizontal bar. In one embodiment, substantially the same user interface is presented for display on both the host system and the portable storage device. In other words, the user interface is displayed by two different pieces hardware. The actual display itself can be addressed by either the host device and/or by the storage processor. For example, the icon 101 is displayed as part of a USB drive 102. Icon 101 can be circular or any other shape. When the USB drive is plugged into a host system (e.g., a personal computer, laptop, server, electronic device, media player, hand-held device, communications device, etc.), the circular icon 103 is displayed as part of a header 104 on a display screen associated with the host system. Although the two circular icons 101 and 103 may be different in size, they are substantially the same in form and appearance. Furthermore, they both portray information to the user in the same manner.

One useful piece of information that the user interface portrays is the amount of storage that is currently being used. This may be conveyed by lighting up a portion of the circle. Given that the entire circle represents the total capacity of the portable memory device, a portion of this circle is lit up to represent how much of that total capacity already contains data. The portion lighted is proportional to the amount of the memory that contains stored data relative to the total storage capacity. For example, if one-third of the total capacity is filled with data, then one-third portion (105 and 106) of the circle is lighted. By glancing at the circular icon, the user can readily estimate how much memory is currently consumed and the amount of memory currently available. It gives the user a quick and intuitive way to gauge the storage capacity at a glance.

The circular icons 101 and 103 can also be used to denote that there is more content to be synced (when in manual sync mode). This can be indicated by varying the intensity of the light emanating from circular icons 101 and 103.

Another condition that can be conveyed by the circular icons 101 and 103 relates to that of synchronization. The appearance of the circular icons 101 and 103 can be changed to reflect when data is being synchronized between the host computer system and the portable memory device. For example, light can be made to continuously move in a circular motion around and about the circular icons 101 and 103 during the entire synchronization process. When the synchronization process completes, the light stops circling. Similarly, when the data on the portable memory device is being backed up or archived, the light can be made to continuously circle around the icon. Different colored lights can be used to differentiate between the synchronization process versus the backup process.

Each of these three different conditions pertaining to the portable memory device can be conveyed by the same, given icon. This is accomplished by utilizing different visual cues corresponding to the icon to reflect the different conditions. By simply glancing at the relatively austere icon, the user can instantly and intuitively be informed of the portable memory device's capacity situation, and synchronization and/or backup progress.

Furthermore, the circular icons 101 and 103 need not be paired up. They can function separately and independently. For example, circular icon 101 of USB drive 102 can be plugged into a host system that does not support a user interface application corresponding to that of the circular icon. In this case, the software and hardware elements embedded within USB drive 102 obtain the necessary information and drive the circular icon 101 to convey the appropriate information (e.g., storage capacity, and synchronization/backup progress).

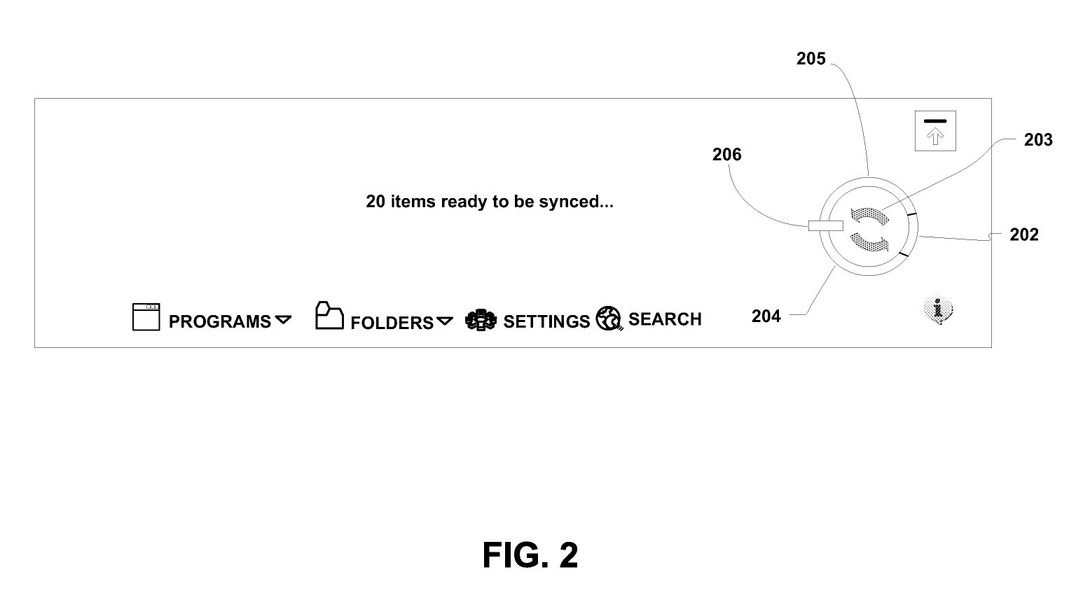

FIG. 2 shows the same circular icon used to convey the amount of storage that will be necessary in order to store a particular selected file or set of files before the file is actually written to memory. The user interface application obtains information regarding the total capacity of the portable memory device and also obtains information from the operating system as to the size of the user selected file. Based on this information, the user interface application can calculate the proportion of the total memory that would be necessary in order to store the selected file. The software automatically knows there is more content to be synchronized and lights up to show the amount of additional storage that will be added. The portion that is lit is the proportionate amount of memory which will be consumed by storing the file. For example, the lighted portion 202 of the circular icon shows that approximately 20% of the total capacity of the portable memory device would be used in order to store the selected file. The portion 204 extending from the horizontal bar 206 counter-clockwise to the edge of the lighted portion 202, represents the amount of memory that is currently consumed. The portion 205 extending from the other edge of lighted portion 202 counter-clockwise to the horizontal bar 206 conveys the amount of memory that would be free or available for storage after the selected file is stored. Thus, at a glance, the user has information regarding how much of the memory is currently used, how much memory the selected file or files would be consume, and how much free memory would be left over.

In one embodiment, a button 203 is displayed within the circular icon. Button 203 can be any shape or size. In this example, button 203 is given by two arrows forming a concentric circle. The button can be clicked on to initiate a function. In one embodiment, a user moves a cursor on the display screen to place the cursor over the button 203 and then clicks a mouse button to invoke the function. In another embodiment, the button could be an actual physical switch. The switch can be housed within a USB drive. The user pushes or toggles the switch to invoke the function. Some functions that can be invoked include loading or backing up data on the USB drive or providing offline functions on the device (e.g., show information that the user chooses to see, such as memory available, owner information in case the USB drive becomes lost, etc.). The user can also click on the button to stop, pause, and resume operations on the USB drive. Consecutive clicks on the button 203 can invoke different functions. For example, clicking the button for the first time can initiate a loading function. Clicking on the button 203 while data is being loaded can cause the USB drive to stop the loading process. After a pre-determined amount of time, the user can click on button 203 again to continue the loading function. The user can also issue multiple clicks on the button to pause and resume loading multiple times.

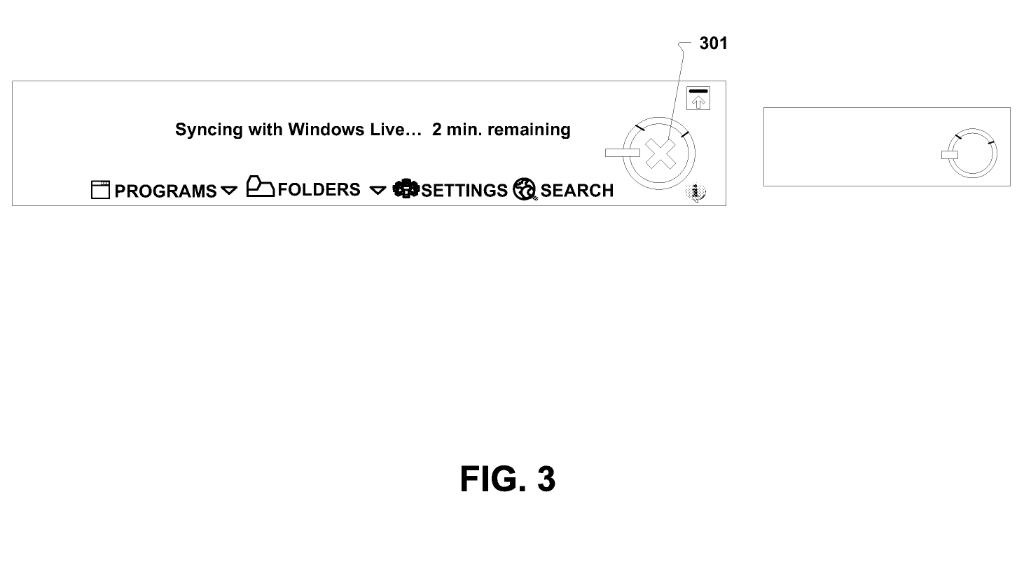

FIG. 3 shows one embodiment of a separate visual indicator that is integrated as part of the circular icon. In this particular embodiment, the visual indicator 301 is in the shape of an “X.” When the “X” is displayed, it means STOP when synchronizing, backing up or file transfer is happening (e.g., circular icon is spinning). In other embodiments, the visual indicator can be some other shape that would denote stop or halt (e.g., a stop sign, circle with a cross through it, exclamation point, etc.). Some additional shapes can be implemented to denote “success” (after synchronizing, backing up, and copying) which is a transient state. There can also be a state that shows “alert” or “warning” when there is some sort of error or conflict.

Different colors can also be used to highlight that it would be unsafe to remove or unplug the USB drive. For example, a green light can mean that it is safe to remove or unplug the USB drive. On the other hand, a red light can mean that it would be unsafe to remove or unplug the USB drive. A light that is revolving about the circular icon indicates that the USB is currently active and is in the process of conducting an operation (e.g., synchronization, backup, data transfer, etc.). When the activity completes or when it becomes safe to remove or unplug the USB drive, a rest or idle state is shown. There is no glyph of the visual indicator shown in the middle of the circle.

Another way to warn the user of a potentially dangerous situation is the use of a flashing visual indicator or perhaps by emitting a warning sound. This separate visual and/or audio indicator is used to provide a warning to the user that it may be unsafe to remove or otherwise unplug the USB device.

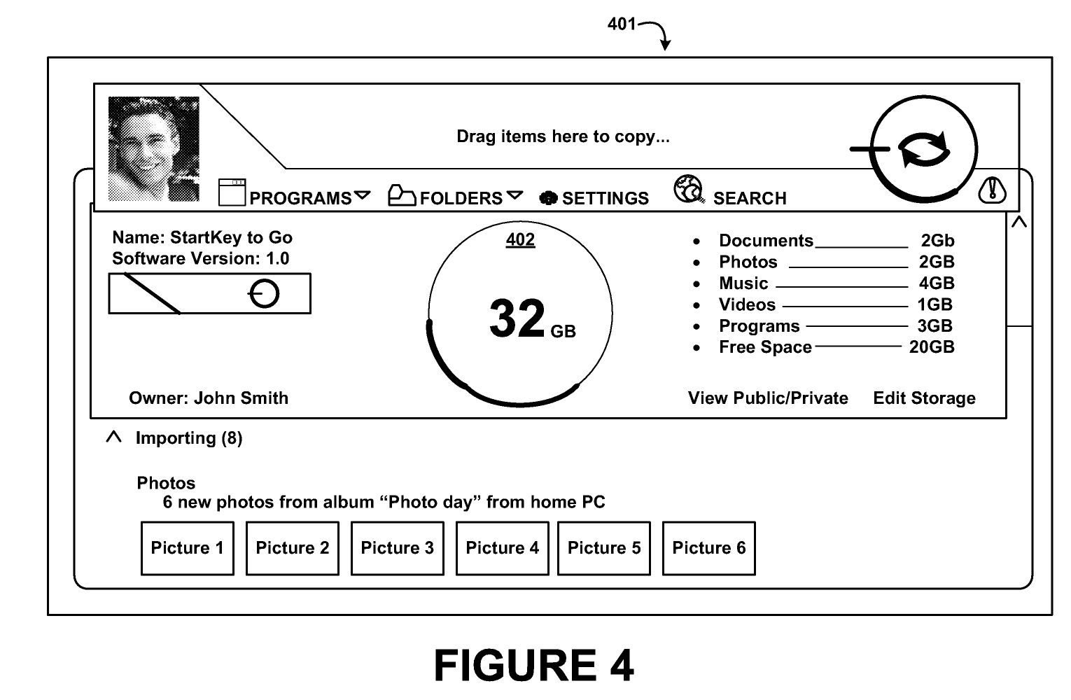

The user interface can also be expanded to provide even more information regarding the portable storage device. FIG. 4 shows a menu 401 which is displayed on the screen of a host system. Menu 401 includes a circular icon (as described above) in the upper right corner. Menu 401 can also display an enhanced view of the circular icon 402. Enhanced circular icon 402 is enlarged to make it easier to view. Within the center (or some other placement) of the enhanced circular icon 402 is displayed the capacity of the portable storage device. In this example, the portable storage device has a total storage capacity of 32 gigabytes (GB). To the right of the enhanced circular icon 402 is a list of the different categories of data currently stored on the portable storage device. For example, the portable storage device contains 2 GB of documents, 2 GB of photos, 4 GB of music, 1 GB of videos, and 3 GB of programs. This leaves 20 GB of free space. To the left of the enhanced circular icon 402 is displayed the name of the portable storage device (e.g., Startkey to Go), the software version (e.g., version 1.0), and the name of the owner (e.g., John Smith). An icon of the portable storage device can also be rendered for display. In this example, the icon is in the shape of a USB drive. When the USB drive is initially plugged into one of the USB ports of the host system, the host USB controller detects the USB drive and automatically generates and displays menu 401.

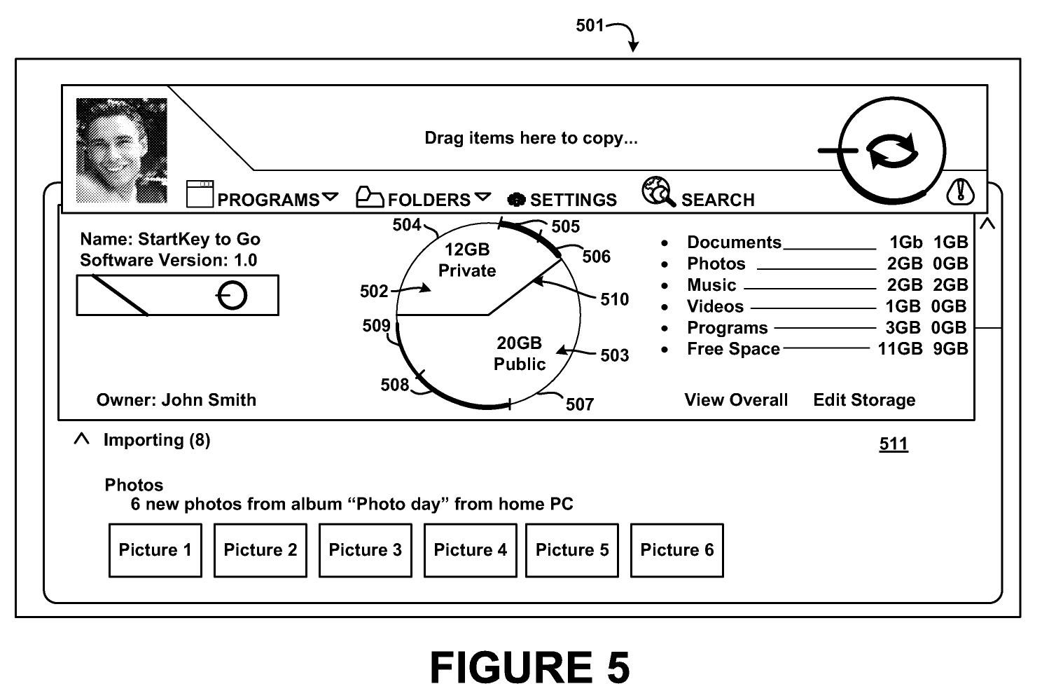

FIG. 5 shows another embodiment of a menu that can be used to portray the state of a portable storage device. The menu 501 is automatically displayed on the host system when the host system detects that a portable storage device has been connected. Menu 501 contains the circular icon, as describe above, in the upper right corner. A list of menu items can also be displayed. Some examples include: Programs, Folders, Settings, and Search. These selectable menu items enable a user to issue commands and invoke functions pertaining to the portable storage device. The enhanced circular icon 502 is displayed within menu 501. Enhanced circular icon 502 can have the same features as that of the circular icon described above plus one or more additional features.

One additional feature is that it can display the private versus public sections associated with the portable storage device. In one embodiment, the enhanced circular icon 502 can be divided into a pie chart. The pie chart shows the relative portions of the memory that is segregated into private versus public sections. For example, the enhanced circular icon 502 can represent the private section as a wedge shape labeled as “Private.” The set amount of private capacity can also be displayed. In this example, the amount of memory dedicated to storing private data is set at 12 GB. Authorization is required to access sensitive or important data stored in the private section. In other words, users are prevented from reading from and writing to the private section of memory unless they are authorized (e.g., password protected). The remaining portion 503 of the enhanced circular icon 502 represents the relative amount of memory that is open to the public. This portion is labeled as “Public.” In this example, 20 GB of the total memory capacity has been set to being publicly available.

In one embodiment, the circular outlines corresponding to Private portion 502 and Public portion 503 can each have different sections, represented by contrasting lighting and/or colors, to represent their current respective storage conditions. For example, the circular outline of Private portion 502 can be divided into three different sections 504, 505, and 506. Section 504 represents the amount of memory available in the private portion. Section 505 and 506 represent areas in the private section that already contain data. The difference between the areas is that they represent different types of content (e.g., music, photos, programs, etc.). Likewise, the circular outline of Public portion 503 can be divided into three different sections 507, 508, and 509. Section 507 represents the amount of memory still available in the public portion. Sections 508 and 509 represent the public portions that contain data. If the user is not selecting a file to be stored, the public and private portions will each have two sections to show private versus public data, and each section shows available storage and storage with data. The sections showing data are color coded to represent different types of data.

In one embodiment, the user can place a cursor over and click on an edge 510 of the wedge separating the private from the public memory of enhanced circular icon 505. The user can then swing or rotate the edge (either clockwise or counter-clockwise) to change the amount of memory that is dedicated to being private versus public. When the desired proportion of private versus public memory is attained, the user can deselect the edge by letting go of the mouse button. Thereby, the user has a convenient, easy way to set the amount of memory dedicated to private and public storage.

In one embodiment, menu 501 can have a separate section 511 that gives additional graphic and/or text information pertaining to the contents and functions of the portable storage device. For example, section 511 can display that the host system is currently importing files from the portable storage device; it can also display the number of files scheduled to be imported. The contents being imported can also be rendered for display as small icons. For example, six small icons of photos can be displayed as they are scheduled for import.

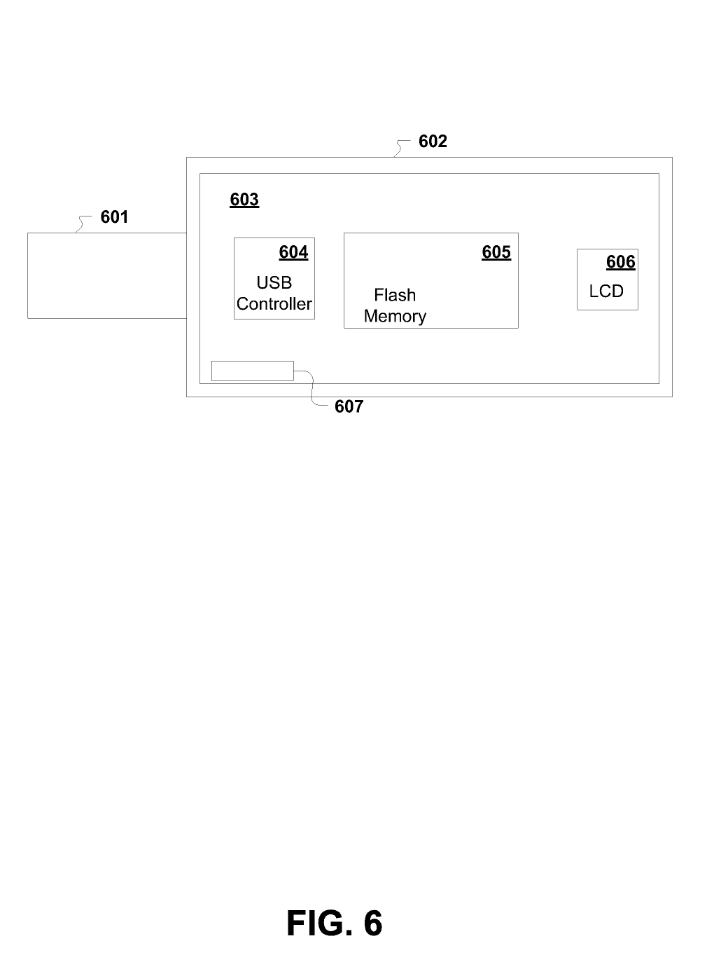

Hardware and software modifications and/or additions to portable memory device controllers and software components are used to implement the user interface. FIG. 6 shows the hardware associated with a USB drive implementing the user interface described above. It should be noted that the portable storage device user interface is not limited to USB drives. The USB drive is offered as an example of a portable storage device to describe how the user interface is made and used. The USB drive includes a connector 601 that is used to electrically couple the USB drive with a host system. The connector 601 is connected to a printed circuit board 603 which is encapsulated within a plastic or metallic body 602. One or more flash memory chips 605 are attached to the printed circuit board 603. The flash memory chips 605 are non-volatile and are used to store the digital data. A USB controller integrated circuit chip 604 contains a small microprocessor and a small amount of on-chip read only memory (ROM) and random access memory (RAM). The software for implementing the user interface described above can reside in the ROM of USB controller 604. Alternatively, the software can reside in a protected portion of flash memory 605. This software instructs the USB controller to generate the appropriate display signals for conveying the current states of the USB drive as described above. The display signals are transmitted to a liquid crystal display (LCD) screen 606, also attached to the printed circuit board 603. It is the LCD screen 606, which displays the circular icon and its functions as described in detail above.

In one embodiment, an application specific integrated circuit (ASIC) chip 607 can be attached to printed circuit board 603. The ASIC chip 607 receives signals from the USB controller 604 and generates the display signals according to the user interface software. The display signals render the circular icon on LCD screen 606. The advantage to using a separate ASIC chip 607 is that any standard USB controller 604 can be used instead of using a specially tailored or modified USB controller.

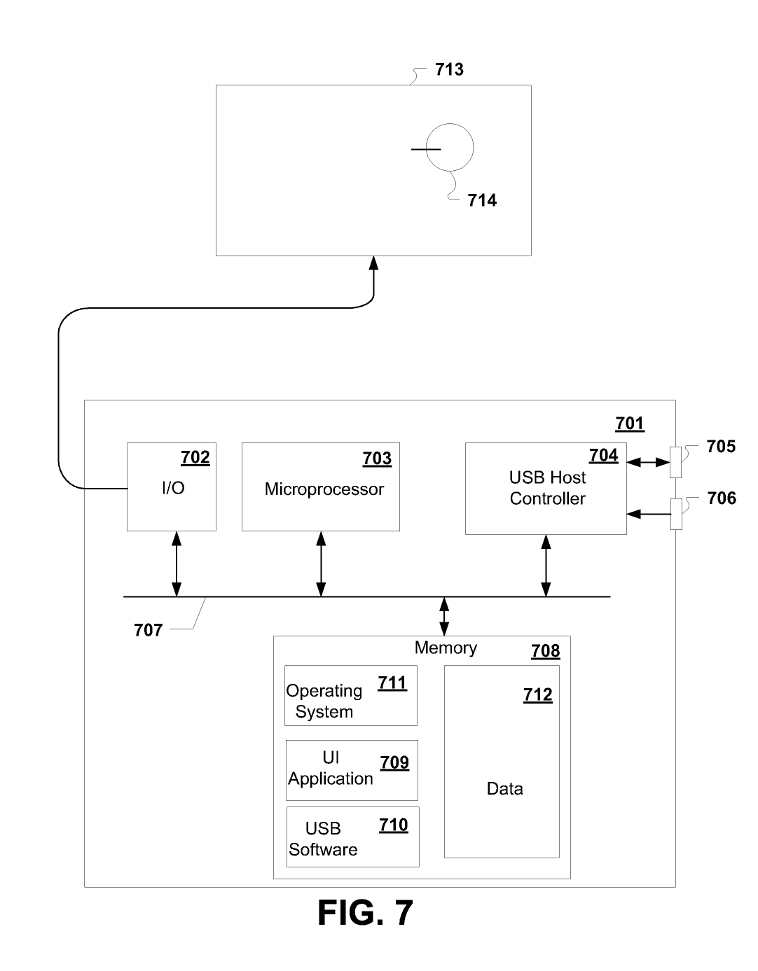

FIG. 7 shows the hardware associated with a host system implementing the portable storage device user interface described above. In this example, the host system 701 is a personal computer. However, the host system is not limited to being a personal computer. Basically, the host system can be any device that benefits from interfacing with a portable storage device. The host system 701 includes one or more USB ports 705 and 706. The USB ports 705 and 706 are used to interface with one more USB drives. Furthermore, additional interfaces coupled to input/output (I/O) interface 702 can electrically connect the host system 701 to other types of portable storage devices. One or more USB drives and other types of portable storage devices electrically coupled to the host system 701 can all individually display the same, uniform user interface design and/or visual indicator (e.g., the circular icon described above).

The I/O interface 702 and USB host controller 704 are coupled to a bus 707. Also coupled to bus 707 is memory 708. Memory 708 represents both volatile (RAM) as well as non-volatile memory (e.g., ROM, hard disk drive, flash memory, etc.). Memory 708 contains user interface (UI) application 709, USB software components 710, operating system 711, and user data 712. The UI application 709 obtains information regarding the state of the USB drive from the USB software 710 and coordinates with the operating system 711 to have the microprocessor 707 generate the appropriate display signals to render a user interface indicator, such as the circular icon 714 and/or menu as described above, for display on screen 713. Likewise, the UI application 709 can obtain relevant information regarding other portable storage devices from their respective device software and render multiple icons for display. Each portable storage device coupled to the host system 701 can have its own icon rendered for display on screen 713. By glancing at all of these icons, a user can quickly and easily assuage the conditions of the various and sometimes disparate portable storage devices.

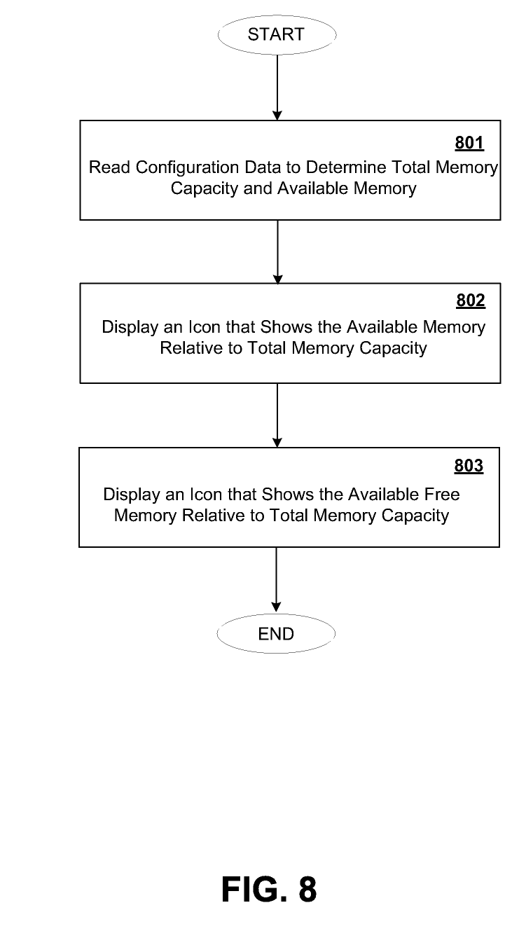

FIG. 8 shows the software process for implementing the user interface for a portable storage device. In step 801, the configuration data is read. The configuration data contains information regarding the total capacity of that particular portable storage device. It also contains information regarding how much of that memory current contains data. In step 802, the software process calculates the proportion of memory that is available for storing data versus the total memory capacity. In step 803, an icon is displayed. The icon gives a visual indication of the available memory relative to the portable storage device's total memory capacity. The icon gives the user a quick check as to how much data he or she can store on that device and also how much data that device currently holds. It basically serves as a “gas gauge” for the portable storage device.

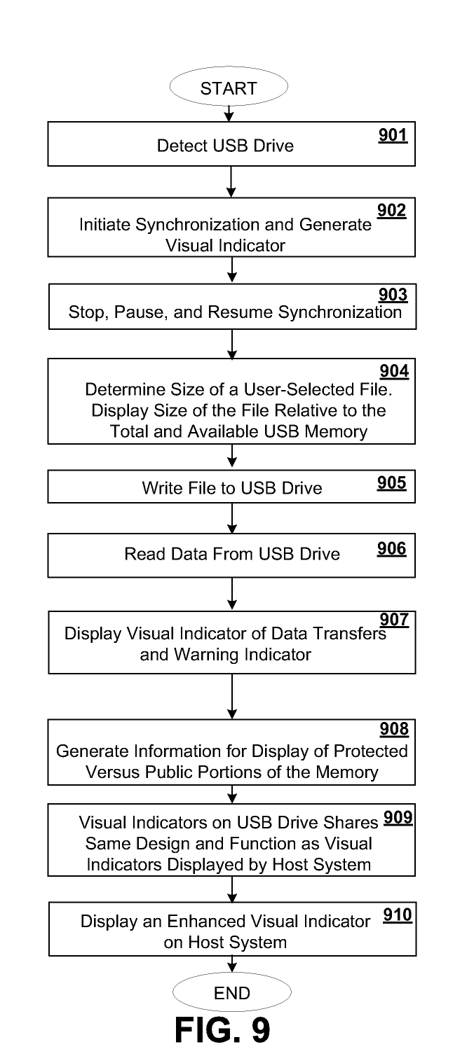

FIG. 9 shows the software process for implementing the user interface for a host system. Initially, in step 901, device software detects when a portable storage device (e.g., a USB drive) is connected to the host system. When a portable storage device is first connected to a trusted host PC (i.e., in a partnership in order to start synchronizing, as well as configuring to automatic synchronization), a synchronization process begins, step 902 (auto sync will be the default option). The synchronization process synchronizes the data on the portable storage device with that of the host system. A visual indicator is displayed on the screen of the host system to inform the user of the progress of the synchronization. In one embodiment, one or more buttons are displayed as part of the user interface. These buttons can be selected to stop, pause, and resume the synchronization, step 903. In another embodiment, buttons can be used to stop, pause, and resume backup as well as read/write operations. In step 904, the user interface application determines the size of a user-selected file. It can then render for display an icon representing the size of the file or files relative to the amount of available memory and also the device's total memory capacity. If no file is selected, the icon displays the amount of available memory relative to the total memory capacity.

Normal data transfers, such as write operations 905 and read operations 906, result in the display of a visual indicator 907 informing the user that read/write operations are currently in progress. A warning indicator can be displayed to the user that it may be unsafe to hot-unplug the portable storage device at this time. In one embodiment, the indicator to show that it is unsafe to unplug is the spinning motion, which means “busy” do not remove.

In step 908, the visual indicator can be changed in a manner to represent the amount of memory that is protected versus the amount of memory that is public. This is shown in the expanded view of the header. In one embodiment, the actual amounts, in gigabytes, of protected and public memory is rendered for display.

In step 909, the visual indicators on one or more portable storage devices (e.g., USB drives) share the same uniform design and function in the same manner as the visual indicators displayed by the host system. This ensures a comprehensive, end-to-end user interface design that is easily understood by the user.

In step 910, the software process can display an enhanced version of the visual indicator. The enhanced version can be made larger and can contain additional information regarding the current progress of the portable storage device as well as give information regarding its contents.

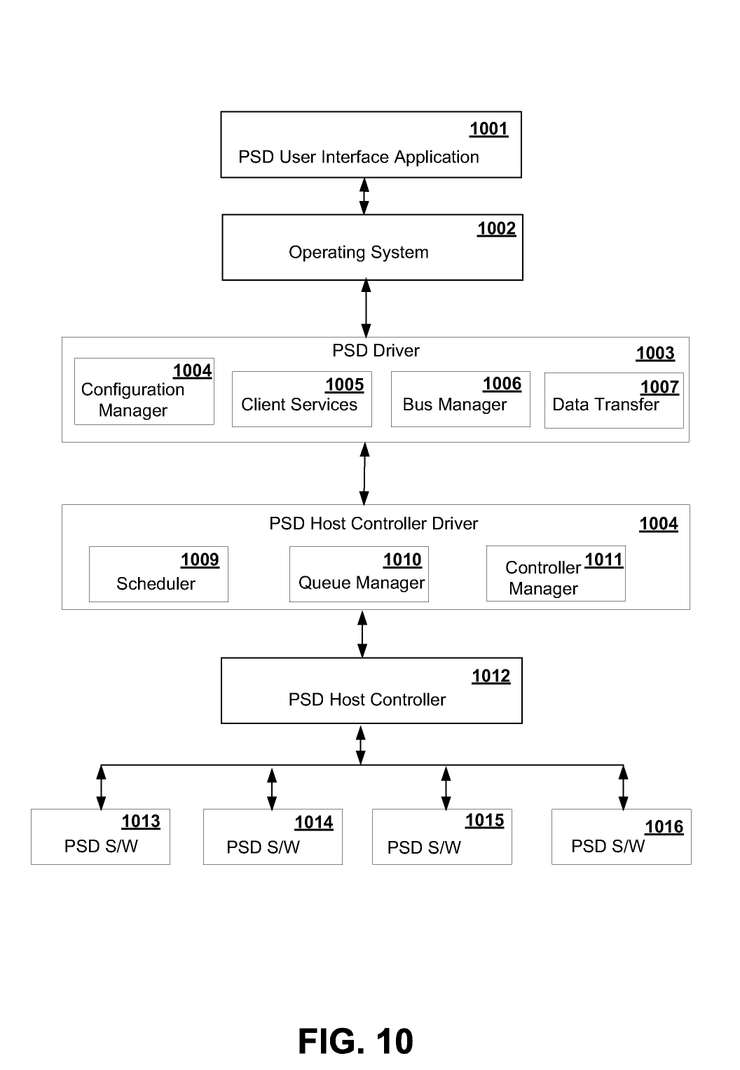

FIG. 10 shows a software architecture that can be used to implement a user interface for portable storage devices. At the top level sits the portable storage device (PSD) user interface application 1001. The PSD user interface application 1001 works in conjunction with the operating system 1002 to obtain the necessary information regarding the configuration and states of one or more various PSDs by means of the devices' embedded client software 1013-1016. The PSD user interface takes this information and uses it to generate the instructions to produce for display the icons and/or other visual indicators for each of the PSD devices 1013-1016. Although one or more of the PSD devices may not have or lack support for its own icon or similar visual indicator, the PSD user interface application 1001 can, nonetheless, generate an icon and/or other visual indicators for that particular PSD device.

The information needed to generate the icon and/or other visual indicators is obtained from PSD driver 1002 and PSD host controller driver 1008. If there are different PSD's there may be multiple drivers and host controller drivers. The PSD driver 1003 has knowledge of the device requirements (by means of device descriptors), as well as knowledge of the PSD's capabilities. The PSD driver 1003 also provides a programming interface which enables client driver's data transfer requests to be performed. In one embodiment, the PSD driver 1002 contains a configuration manager 1004, client services component 1005, bus manager 1006, and data transfer block 1007. The PSD host controller driver 1008 provides the low level support for the PSD software 1013-1016. In one embodiment, the PSD host controller driver 1008 includes a scheduler 1009, a queue manager 1010, and a controller manager 1011. The PSD host controller 1012 interfaces between the PSD host controller driver 1008 and the PSD client software 1013-1016. The details of the PSD driver 1003, PSD host controller driver 1008, PSD host controller 1012, and PSD client software 1013-1016 can be found in the specification for the USB 2.0 and 3.0 standards.

Therefore, a user interface for a portable storage device is disclosed. It should be noted that the user interface works with any portable storage device or any device that stores digital data and can be physically carried or moved about by a single person. The USB drive is just one example of a portable storage device. Other portable storage devices may or may not be USB compliant. The storage technology may include, but are not limited to magnetic memory (e.g., hard disk drives) and semiconductor-based memory (flash memory). Other examples may include SATA external connectors, Flash memory devices on a 1394 connector, and portable storage drives that are connected via an electrical connector that provides high speed data transfers. These devices offer data accessibility without requiring tools and are capable of being connected and disconnected without regards to the power being turned on or off.

Furthermore, many different types of display technologies, not limited to LCD displays, can be used to display the user interface. And although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A portable storage device comprising:
a non-volatile storage memory;
a processor coupled to the non-volatile storage memory;
a multi-function display addressable by the processor or a host device that displays a visual indicator that shows how much of the memory contains data and how much of the memory is available to store additional data.

2. The portable storage device of claim 1 further comprising:
an interface to a host system, wherein the host system displays a visually similar indicator as the visual indicator of the portable storage device.

3. The portable storage device of claim 1, wherein the visual indicator shows when synchronization is in progress.

4. The portable storage device of claim 1, wherein the visual indicator shows how much of the available memory would be consumed if one or more files were to be stored in the memory.

5. The portable storage device of claim 1 further comprising at least one button to invoke at least one function.

6. The portable storage device of claim 1, wherein the button is used to stop, pause, and resume actions.

7. The portable storage device of claim 1, wherein visual indicators show when it is unsafe to unplug the portable storage device from a host system, a transitory indication of a success or completion of an activity, and an alert that indicates an error or conflict condition.

8. The portable storage device of claim 1, wherein the visual indicator shows when there is activity.

9. The portable storage device of claim 1, wherein the visual indicator shows a protection level in an expanded view of a header.

10. The portable storage device of claim 1, wherein the visual indicator comprises a circle with different portions having different lighting to indicate storage conditions.

11. The portable storage device of claim 1, wherein the portable storage device comprises a USB drive.

12. A host system comprising:
a processor;
a memory coupled to the processor;
an interface coupled to the processor that is used to couple the host computer to a portable storage device, wherein the portable storage device has a first icon that displays a state of the portable storage device;
a display coupled to the processor, wherein the processor generates a second icon that is similar in appearance and has a same function as the first icon.

13. The host system of claim 12, wherein the second icon displays storage information, synchronization, backup, and file transfer information, protection information, and activity information pertaining to the portable storage device.

14. The host system of claim 12, wherein the second icon is part of a header of a menu that displays information regarding the portable storage device.

15. A method for generating a user interface for a portable storage device that is capable of being coupled to a host system, comprising:
displaying a first icon on the portable storage device that conveys information regarding the portable storage device;
displaying a second icon on the host system, wherein the second icon has a similar appearance and a same functionality as the first icon.

16. The method of claim 15 further comprising:
determining a total memory capacity of the portable storage device and a current amount of the memory that is available for storing data;
the first icon and the second icon displaying a visual indication that portrays the current amount of memory that is available for storing data relative to the total memory capacity.

17. The method of claim 15, wherein the functionality includes an indication of when the portable storage device is synchronizing with the host system, when there is data transfer activity, an error or conflict condition, successful completion of an activity, and when it is unsafe or safe to decouple the portable storage device from the host system.

18. The method of claim 15 further comprising:
generating a menu for display by the host system, wherein the menu portrays content information regarding the portable storage device.

19. The method of claim 15, wherein an enhanced icon is generated for displaying additional information regarding the portable storage device.

20. The method of claim 19, wherein the additional information conveys a public section of the memory and a private section of the memory.
